(19) United States
(12) Patent Application Publication
(10) Pub. No.: US 2024/0122679 A1
(43) Pub. Date: Apr. 18, 2024

(54) MECHANICAL DENTAL BONDING SCRUBBING APPARATUS

(71) Applicant: Jagjot RANDHAWA, Brampton (CA)

(72) Inventor: Jagjot RANDHAWA, Brampton (CA)

(21) Appl. No.: 17/967,989

(22) Filed: Oct. 18, 2022

(51) Int. Cl. A61C 8/00

(52) U.S. Cl. CPC A61C 8/0054; A61C 8/0066; A61C 8/0069

(57) ABSTRACT

A mechanical dental bonding scrubbing apparatus with timer that can be used in bonding protocol of dental adhesives or composite fillings, characterized by being formed by a main body configured to receive a microbrush and equipped with a timer that has a time counting element that can be programmed for lagged timing with different notification sounds. The apparatus can be used with regular micro brushes available currently for use.

### FIELD OF THE INVENTION

The present invention relates in general to dentistry and in specific to restorative dentistry to aid bonding protocol.

### BACKGROUND OF THE INVENTION

Dental bonding, sometimes called composite bonding or teeth bonding, is most commonly used practice in restorative dentistry for filling the teeth and to cosmetically enhance the appearance of the teeth. During the procedure, the dentist applies the bond or adhesive to the tooth surface and cures it with UV light before adding the composite which are commonly used for filling the cavities.

The procedure uses tooth-colored composite resin material to:
Conceal chips or cracks in the teeth;
Camouflage tooth discoloration;
Close gaps and spaces between the teeth;
Make the teeth look longer, and
change the shape of the teeth.

Dental bonding is very common. In fact, it's one of the most frequently performed procedures in dentistry today. Through the bonding process the dentist will roughen the surface of the tooth and apply a conditioning liquid. These procedures help the bonding material adhere to the tooth. The tooth-colored resin is applied, molded, and smoothed to the desired shape. The material is hardened with a bright (usually blue) light or laser. After the material hardens, the dentist will further trim and shape it, then polish it to match the sheen of the rest of the tooth surface.

Teeth bonding usually takes about 15 to 30 minutes per tooth to complete. Because of some of the limitations of dental restorative, some dentists view it as best suited for small cosmetic changes, for short-term correction of cosmetic problems, and for correcting teeth in areas of very low bite pressure or fill the decayed teeth, broken or chipped teeth.

The standard protocol of rubbing the bonding agent for 20 seconds is usually not followed by dentists, thus compromising the bond strength between dental restoration of tooth. Currently available methods and devices are just manual scrubbing, especially with self-etching dental bonds. The most important part of this procedure is to scrub for 15-20 seconds to remove smear layers. Most of times, dentists do not scrub for this amount of time and rush through the process. They do not keep the bonding agent in place for 15-20 seconds, causing decrease in bonding efficiency. The presently invention is aimed at addressing this issue.

### SUMMARY OF THE INVENTION

The present invention is a mechanical dental bonding scrubbing apparatus for use in bonding protocol of dental adhesives or composite fillings. The apparatus is used for scrubbing of dental bonding agent with timer. The timer can be programmed for lagged timing with different beeping sounds for multiple teeth. The apparatus can be used with regular microbrushes available currently for use.

The improvement that this apparatus introduces is that it adds to the models up to now designed the time dimension. So it just supplements models that are used at the moment focused in the way that scrubbing is done adding time control advantage, all in one unit. The solution is to insert a timer with automatic time-end warning emission that enables its activation and di-activation in a simple way and a clearly perception of the warning signal. Scrubbing time will be controlled by the time passed between timer activation and warning emission, time that will be programmed to an optimum value considered by the dentist based on the bonding protocol, the area and the patient.

The present apparatus comprises of a body with a handle that includes a timer and a signaling means. The apparatus is configured to receive a standard interchangeable microbrush. A motor engages the microbrush and moves back and forth in peaking motion or sideways. The frequency can be changed from 3 to 15 per second to remove the smear layer. The apparatus is battery powered, which can be charged.

The apparatus can be operated by pressing a start button to initiate the timer and oscillation of microbrush at the same time, which can be programmed for different times like 15 seconds, 20-25 seconds. In one embodiment, the apparatus includes at least one processor and memory including a set of instructions configured to cause the apparatus to be programmed for various modes.

Therefore, it is an object of the present invention to allow for a time controlled mechanical dental bonding scrubbing apparatus, so that the dentists do not have to guess the time or look at other timers to follow the bonding time.

It is another object of the present invention to provide a programmable mechanical dental bonding scrubbing apparatus. This allows for a better bonding protocol.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A is a first perspective view of the mechanical dental bonding scrubbing apparatus, according to an embodiment of the present invention,

FIG. 1B is a second perspective view of the apparatus, according to an embodiment of the present invention,

FIG. 2 is a cross-sectional top view of the apparatus, according to an embodiment of the present invention,

FIG. 3 is an exploded view showing the parts of the apparatus, according to one embodiment of the present invention,

FIG. 4A is a cross-sectional side view showing the connection of the microbrush inside the apparatus according to an embodiment of the present invention;

FIG. 4B is a cross-sectional side view showing the connection of the microbrush inside the apparatus according to an embodiment of the present invention;

FIG. 5 shows the inside of the apparatus and a close-up view of the motor and the connection of the motor to the motor shaft;

FIG. 6 is an exploded view of the apparatus showing the top portion and the panel, and

FIG. 7 is a perspective view showing the rechargeable battery part of the apparatus.

### DETAILED DESCRIPTION OF PREFERRED EMBODIMENTS

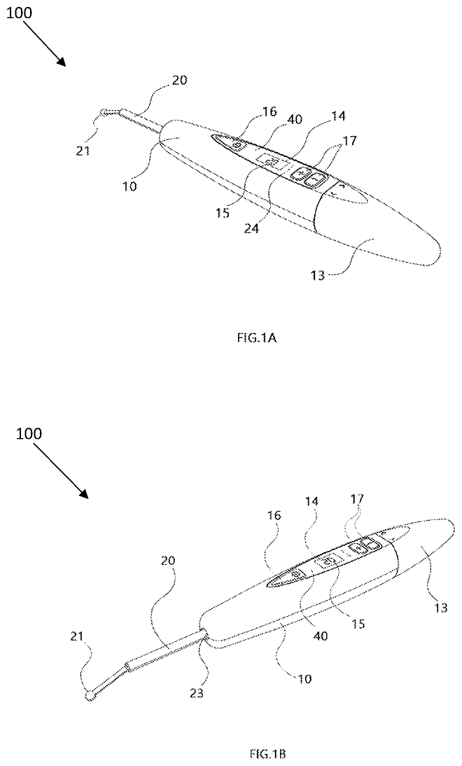

Referring to FIG. 1A to 3 the apparatus 100 includes a body 10 configured to receive a standard interchangeable microbrush 20. In one embodiment the body comprises of a top portion 11 and a bottom portion 12 connected to each other for housing various parts of the apparatus 100. The body part 10 is used as a handle of the apparatus 100. The body 10 further has a first end that has an opening 23, a second end and a cylindrical section 34 inside the housing at the first end to receive a microbrush through the opening 23.

The top portion 11 has a panel 40 mounted thereon. The panel 40 includes a display screen 14. A programmable timer 15 is embedded in the display screen 14. The timer 15 may include a speaker 24 to provide an automatic time-end warning sound emission that enables its activation and di-activation. The programmable timer 15 can be programmed by the dentist based on a specific bonding protocol. The timer can be electronic-digital type. The apparatus 100 can be used with regular microbrushes available currently for use.

The apparatus 100 further includes ON/OFF button 16 and a mode change button 17 mounted on the panel 40. When the timer 15 is turned on or reset via the ON/OFF reset button 16 and a time is displayed on the display screen 14, said time is sequentially adjusted accordingly and displayed on the display screen 14 until the time is expired at which time a signaling means is activated such that an audio signal is emitted via the speaker 24 functioning to alert the user when said time limit is reached, so that the dentist doesn't have to guess the time or look at other timers to follow the bonding time.

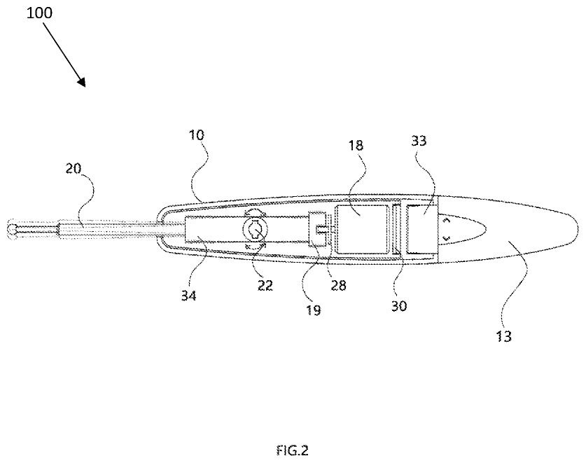

Referring to FIG. 2 a motor 18 is mounted in the body 10 of the apparatus 100 and engaged to the microbrush 20 to enhance mechanical movements in the microbrush 20 either back and forth or from right to left in peaking motion or sideways at a frequency of 3 to 15 per seconds. The frequency of the movement can be changed from 2 strokes per second to 8-10 per seconds to remove the smear layer from the teeth. The motor 18 can be any small direct current motor. the drive shaft is coupled to cylindrical section 34 through a coupling mechanism to cause a mechanical movement on the microbrush with a predetermined frequency.

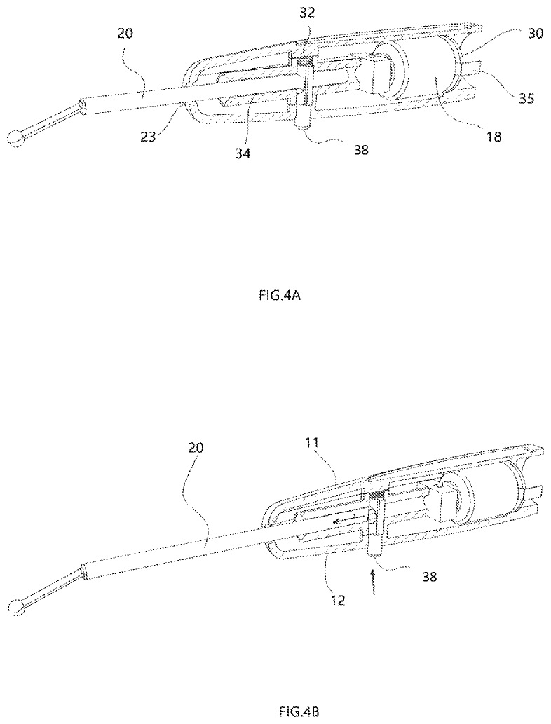

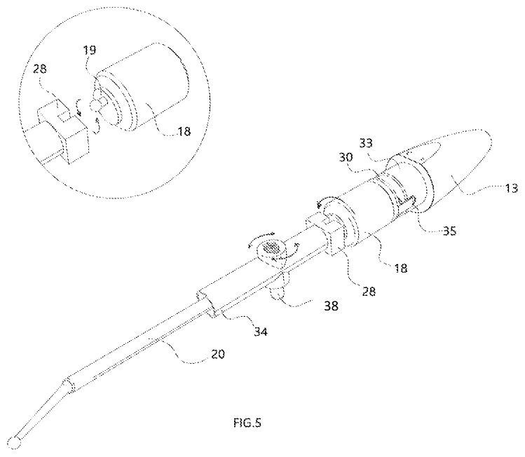

As shown in FIGS. 2 to 5 the microbrush is connected to a motor drive shaft 28 via a coupling 19. The motor drive shaft 28 is driven by the motor 18. The motor 18 is controlled by a circuit board 30 and powered by batteries 33. The circuit board has connectors 35 to connect to batteries 33, The circuit board 30 is provided to control the direction and duration of the motor 18 and is selected preferably from a low power-consuming circuit boards and has at least one processor and a memory to control the mechanical movement of the microbrush.

The motor 18 drives the motor drive shaft 28 which transmits the power to the microbrush 20 via the coupling 19. The circuit board 30 further is configured to control the time, based on a predetermined time set of the apparatus and to provide a set of predetermined time periods for scrubbing. The apparatus 100 displays the time 15 and projects a sound from the speaker 24 for a set period of time.

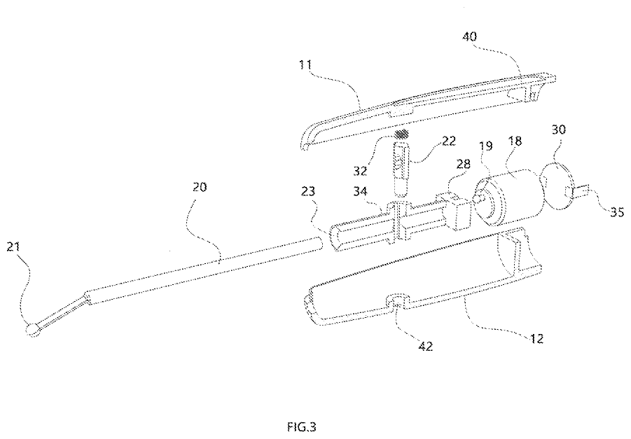

FIG. 3 shows an exploded view of the apparatus 100. The body portion 10 houses a hollow cylindrical section 34 which receives a microbrush 20. The microbrush 20 is being inserted into the apparatus through an opening 23 and locked therein. A locking mechanism 22 installed on the cylindrical section 34 to lock the microbrush inside the body 10. Any suitable connecting system can be used for connecting the microbrush 20 inside the cylindrical section 34.

In the preferred embodiment the apparatus has a Snap-on locking mechanism 22 on the cylindrical section 34 for releasably connecting a microbrush 20. The microbrush 20 is adapted to slidably inserted into the apparatus 100. The Snap-on locking mechanism 22 includes a spring 32 to provide a quick releasable locking mechanism for retaining the microbrush 20 in locked relation with the apparatus 100.

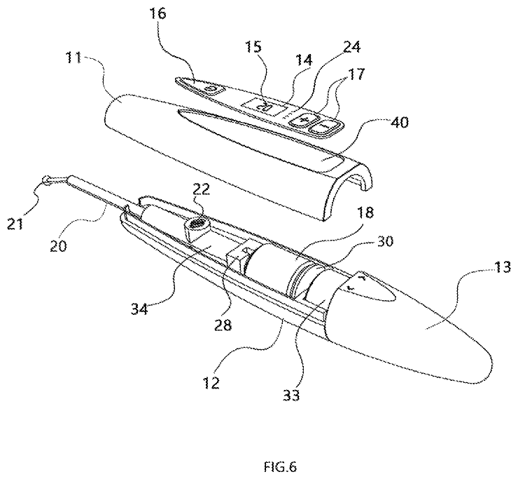

FIGS. 3 to 6 show clearly the locking mechanism 22. The bottom portion 12 has an opening 42 for the spring release button 38. The locking mechanism 22 comprises of a rod 31 having an aperture 36 to receive the microbrush 20. The rod 31 is placed perpendicular to the cylindrical section 34, and engages with a spring 32 from a first end of the rod and a spring release button 38 at the second end of the rod 31. When the microbrush 20 is inserted into the cylindrical section 34, the spring release button 38 is pushed to let the microbrush to pass through the aperture 36 of the rod 31, and when the spring release button 38 is released the microbrush 20 is locked by a spring force.

The microbrushes 20 used are standard which are already in use and are disposable. Any size from extra small to large size microbrushes can be fitted into apparatus. The head 21 of the microbrush is used to scrub the teeth.

The essential advantages of the invention is the timing which can be achieved without the aid of external auxiliaries. The signaling time corresponds to the time span which is regarded by bonding protocol as being the optimum time for which the teeth should be scrubbed.

In one embodiment, the apparatus 100 is programmed with various time and oscillation of microbrush at the same time, which can be programmed for different times like 15 seconds, 20-25 seconds. The apparatus includes at least one processor and memory including a set of instructions configured to cause the apparatus to be programmed for various modes.

The body 10 can be made of plastic, metal, or any other material that can be formed into the shapes of these pieces. The body can be formed as one piece or as two pieces through an injection molding process and is ergonomically designed to accommodate a user's grip. The mechanical elements of the apparatus 100 include the motor 18, the motor drive shaft 28, the coupling 19, the drive shaft 15 can be made of any suitable material that can withstand the mechanical forces and environmental conditions of the device and can be molded of for example plastic material 13.

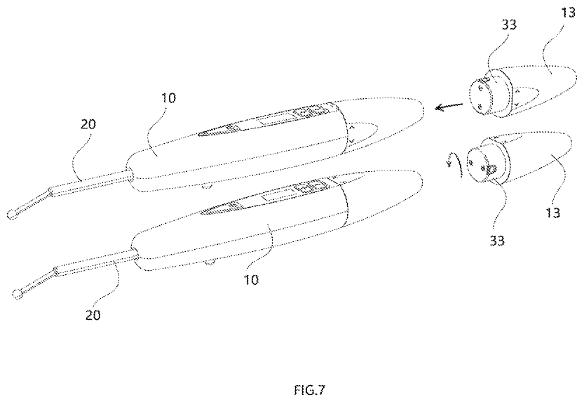

According to FIG. 7 the apparatus 100 is battery powered and includes batteries 33 for operation of the apparatus. The batteries are embedded on the proximal end of the body 10 which can be rechargeable batteries. The battery part is sealed by a battery cap 13. The batteries 33 can be any sized cell battery such as lithiumion, lithium, nickel metal hydride, lead acid, or alkaline batteries.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A mechanical dental bonding scrubbing apparatus, the apparatus comprising:
a) a body having a first end that has an opening, a second, and a housing inside the body, wherein the housing comprising:
i) a cylindrical section at the first end to receive a microbrush through the opening;
ii) a locking mechanism installed on the cylindrical section to lock the microbrush inside the body;
b) a motor having a drive shaft installed in the housing, wherein the drive shaft is coupled to the cylindrical section through a coupling mechanism to cause a mechanical movement on the microbrush with a predetermined frequency;
c) a programmable timer to control an operation time of the apparatus, and
d) at least one processor and a memory to control the mechanical movement of the microbrush and to provide a set of predetermined time periods for scrubbing.

2. The apparatus of claim 1, wherein the locking mechanism comprises of a rod having an aperture to receive the microbrush, wherein the rod is placed perpendicular to the cylindrical section, and wherein the rod engages with a spring from a first end of the rod and a spring release button at the second end of the rod,
whereby when the microbrush is inserted into the cylindrical section, the spring release button is pushed to let the microbrush to pass through the aperture of the rod, and when the spring release button is released the microbrush is locked by a spring force.

3. The apparatus of claim 1, wherein the mechanical movement of the microbrush is preprogrammed based on a bonding protocol at a frequency of 3 to 15 per seconds.

4. The apparatus of claim 1, wherein the set of predetermined time periods for scrubbing is 15 to 20 seconds.

5. The apparatus of claim 1, wherein the cylindrical section is configured to receive a standard disposable microbrush from extra small to large size microbrushes.

6. The apparatus of claim 1, wherein the coupling mechanism to cause a mechanical movement in the microbrush is configured to provide a back and forth, or right to left peaking motions.

7. The apparatus of claim 1, comprising a display panel on a top portion of the body to display and count down the set of predetermined time periods for scrubbing.

8. The apparatus of claim 1, comprising a speaker to provide a sound for the set predetermined time periods and to signal time-end warnings.

9. The apparatus of claim 1, comprising an ON/OFF button and a mode change button.

10. The apparatus of claim 1, comprising a power system comprising a set of regular or rechargeable batteries.

11. The apparatus of claim 1, wherein the body comprising a top portion and a bottom portion that are removably attached to form the hosing.
